(19) United States
(12) Patent Application Publication
(10) Pub. No.: US 2007/0053290 A1
(43) Pub. Date: Mar. 8, 2007

(54) Packet attribute based prioritization

(75) Inventor: Peter Michels, Cupertino, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/504,634

(22) Filed: Aug. 16, 2006

Related U.S. Application Data
(60) Provisional application No. 60/713,359, filed on Sep. 2, 2005.

(51) Int. Cl. H04L 12/26

(52) U.S. Cl. 370/230

(57) ABSTRACT

An apparatus and method to optimize latency and bandwidth in a system include a queue configured to receive control data packets of a control stream, and an arbiter. The arbiter is operatively connected to the queue and configured to set a threshold level defining a priority to transmit and process each control data packet, to read header attribute information associated with the control data packet, and to determine, based on the header attribute information included in the control data packet, a length of each control data packet. The arbiter is configured to compare the length of each control data packet with the threshold level to prioritize transmission of the control data packets.

### BACKGROUND OF THE INVENTION

1. Field of the Invention

The present invention relates to processing of packet attributes to identify critical packets and, more specifically, to optimizing packet processing by identifying and prioritizing critical data packets.

2. Description of the Related Art

A packet switched network is one in which data is communicated as discrete packets, each packet containing a header. The header contains information regarding the packet's source, ultimate destination, etc. For instance, in the case of a Transmission Control Protocol (TCP)/Internet Protocol (IP) packet, the header includes the IP source address, TCP source port, the IP destination address and the TCP destination port. Each packet is individually transmitted to its ultimate destination through a series of network switches (bridges, IP switches, IP routers, layer 4 load balancers, etc.). Most network switches examine the header to determine the packet's ultimate destination, and the network switch decides how to forward the packet based on this header information. A network switch that operates in this manner remains “ignorant” of the packet content since the actual content of the packet is irrelevant in making forwarding decisions.

Recently, network switches (e.g. bridges, IP switches, IP routers, layer 4 load balancers, etc.) have emerged, which are “content aware”. These types of switches are often referred to as “content switches”. Content switches are embedded with specific knowledge of, and monitor or participate in, the upper layer protocols (e.g., HTTP etc.). Content switches examine and sometimes modify the packets of data transmitted through the network. These content switches are typically designed around a packet-oriented switch fabric similar to the way bridges, IP routers and layer 4 load balancers are designed. In some instances, content switches may also perform bridging, routing and load balancing functions.

Conventional content switches have been made content aware only for applications that are popular and that will benefit from content aware switching or processing. These applications have been and likely will continue to be stream-oriented applications. A stream is a series of bytes transferred from one application to another and stream-oriented applications create or manipulate data as streams of bytes. In the case of a stream being transmitted within a packet switched network, the stream of data is divided and transmitted via a flow of packets, a flow of packets being a bidirectional set of packets going between two end points within two end stations.

However, current systems do not provide packet attribute prioritization based control on user or application requirements between information types being transmitted over a network. Further, routing is not based on the control streams being transferred. Rather it is based only on data streams having certain well-defined, limited attributes such as originator address, destination address, size of object and type of packet of data. Such attributes do not lead to a most efficient transmission of information in mixed usage networks. Data streams may be processed sequentially, round robin, or based on header information. In current systems, there is not explicit information designating packet type or importance, therefore, the packets in the control stream cannot be prioritized.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates an apparatus to prioritize control streams, in accordance with an embodiment of the present invention;

FIG. 2 illustrates a method to prioritize control data packets when at least one programmable threshold level is defined, in accordance with an embodiment of the present invention; and

FIG. 3 illustrates a method to prioritize control data packets when multiple programmable threshold levels are defined, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. The present invention described below provides a novel approach of prioritizing data packets in a control stream using a length of each control packet, thereby improving system performance such as latency or bandwidth. A control device is provided configured to allow measuring a length of a data packet in a control stream and to compare the length with a programmable threshold level. The control device and method thereof would prioritize processing of the data packet based on the comparison.

Control streams may be of different lengths than data streams in some PCI Express applications, such as Infiniband™. A new generation of I/O infrastructure called InfiniBand™ has been introduced InfiniBand™ addresses the need to provide high-speed connectivity out of the server. It enhances the ability to transfer data better than present shared bus architectures. InfiniBand™ architecture is a creation of the InfiniBand Trade Association (IBTA). Control stream latency is more critical to the overall system performance than data latency. In order to improve control packet latency, packet attributes designated for one purpose may be used implicitly to identify critical control packets to optimize packet processing and system performance, including latency and bandwidth provisioning.

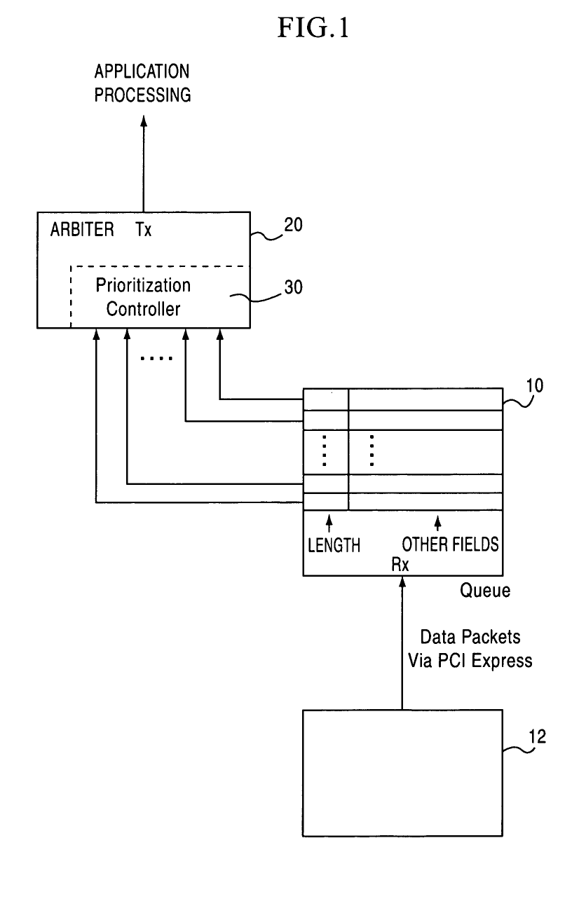

FIG. 1 illustrates an exemplary case in which control streams are sent directly to a queue 10 and an arbiter 20 to prioritize the control streams, in accordance with an embodiment of the present invention. The control streams may be sent over one or more transmission control protocol (TCP) connections (not shown), in which a network may be a Memory Mapped, I/O Expansion Network, such as PCI, PCI-X, or PCI-Express. Also, the network can be a system area network, such as InfiniBand™. As illustrated in FIG. 1, data packets of a control stream are transmitted from a packet source 12 to the queue 10. The queue 10 includes multiple entries, each holding a control data packet of a particular length. Thus, for each entry in the queue 10, a length of the field is provided.

An arbiter 20 including a prioritization controller 30 is provided to be operatively connected to the queue 10. The arbiter 20 is used as a control device to manage a datapath between the queue 10 and other application processing units (not shown) that ultimately receive and process the control streams and data streams for a particular application. In addition, the arbiter 20 receives header attribute information associated with each data packet (referred to as control data packets) of the control stream received at the queue 10 and determines, based on the header attributes included in the control data packet, the length defined for each corresponding control data packet.

The prioritization controller 30 in the arbiter 20 would read each attribute or field in the queue 10 including the control data packet of a particular length. The prioritization controller 30 would prioritize the control data packets based on the length of each control data packet. Thus, once the prioritization controller 30 determines the length for each control data packet, the data packet is prioritized based on the corresponding length. The shorter the length, the prioritization controller 30 would define the priority of the corresponding control data packet as a higher priority. Once the control data packet of the control stream is determined to be of a high priority, the prioritization controller 30 outputs the data packet other application processing units for further processing.

In order to define or determine the priority of the data packet based on the length, the prioritization controller 30 may define a single programmable threshold of, for instance, 128 bites, or may define various programmable threshold levels. If various programmable threshold levels are defined in the prioritization controller 30, each programmable threshold level would indicate a priority to be given to a particular data packet. If a single programmable threshold level is defined, then the each control data packet may be either a high priority control data packet or a low priority control data packet.

For instance, assuming that five programmable thresholds are defined in the prioritization controller 30, a highest priority may be defined to correspond to a first programmable threshold level and a lowest priority is defined to correspond to a fifth programmable threshold level. Each length of each control data packet would be compared to the first programmable threshold level. If the length of the control data packet is less than the first programmable threshold level, then the prioritization controller 30 would determine that the control data packet should be transmitted and processed with the highest priority. If the length is greater than the first programmable threshold level, the prioritization controller 30 would then proceed and compare the length of the control data packet with a second threshold and so forth until the prioritization controller 30 determines that the length of the data packet is less than a programmable threshold level. For instance, if the particular control data packet has a length less than the fifth threshold, then the prioritization controller 30 would determine that the particular control data packet has a lowest priority. The fifth or last programmable threshold level may be programmed during set-up to be greater than a longest expected or permissible length of the control data packet to be received by the prioritization controller 30.

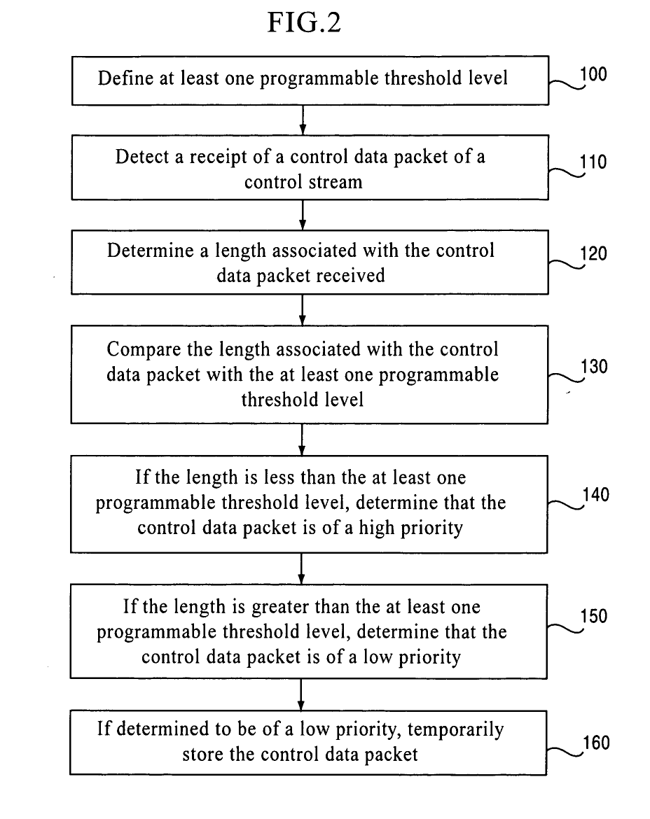

FIG. 2 illustrates a method to be executed to prioritize control data packets of a control stream when at least one programmable threshold level is defined, in accordance with an embodiment of the present invention. At operation 100, the method defines the at least one programmable threshold level, indicative a high priority level to process the control data packet.

At operation 110, the method detects a receipt of a control data packet of a control stream. At operation 120, the method determines the length associated with the control data packet received. At operation 130, the method compares the length associated with the control data packet with the at least one programmable threshold level. If the length associated with the control data packet is less than the at least one programmable threshold level, at operation 140, the method determines that the control data packet is of a high priority and, therefore, should be transmitted and processed before other control data packet in the control stream.

However, if the length associated with the control data packet is greater than the at least one programmable threshold level, at operation 140, the method determines that the control data packet is of a low priority and, therefore, may be transmitted and processed after other control data packet with a higher priority. If determined to be of a low priority, at operation 150, the method may temporarily store the control data packet in a buffer while waiting to transmit the control data packet after that control data packet or packets having a high priority.

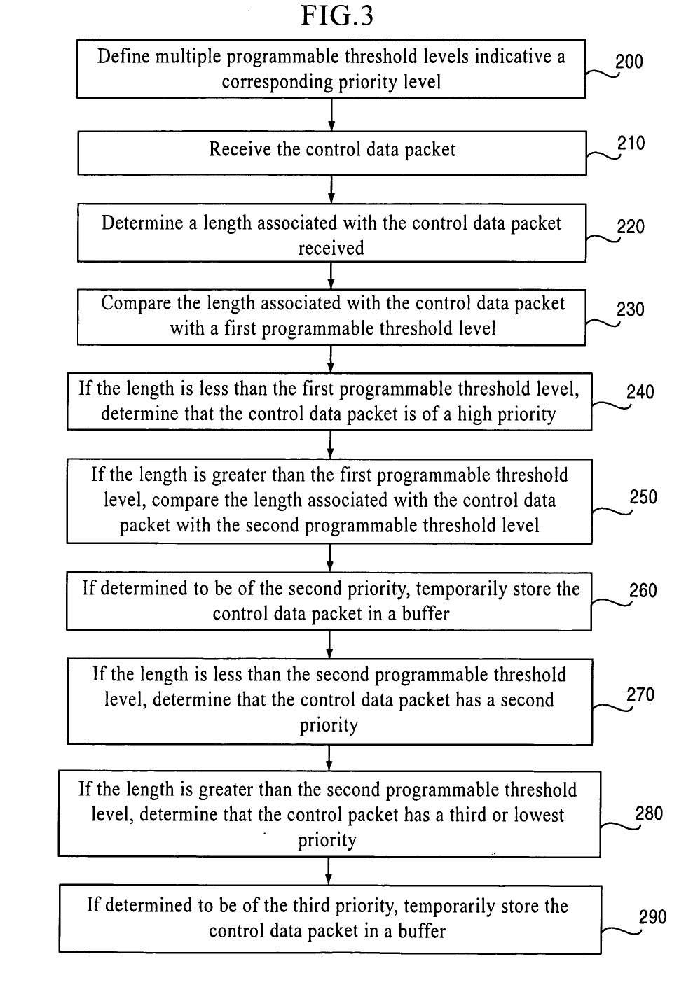

FIG. 3 illustrates a method to be executed to prioritize control data packets when multiple programmable threshold levels are defined, in accordance with an embodiment of the present invention. At operation 200, the method defines each programmable threshold level indicative a corresponding priority level. For illustrative purposes, the method defines three programmable threshold levels including a first programmable threshold level, a second programmable threshold level, and a third programmable threshold level to prioritize and process accordingly the control data packet. For illustrative purposes, the first programmable threshold level is defined as a first or highest priority, the second programmable threshold level is defined as a second or intermediate priority, and a third programmable threshold level is defined as a third or lowest priority.

At operation 210, the method receives the control data packet. At operation 220, the method determines the length associated with the control data packet received. At operation 230, the method compares the length associated with the control data packet with the first programmable threshold level. If the length associated with the control data packet is less than the first programmable threshold level, at operation 240, the method determines that the control data packet is of a high priority and, therefore, should be transmitted and processed before other control data packet of the control stream.

However, if the length associated with the control data packet is greater than the first programmable threshold level, at operation 250, the method compares the length associated with the control data packet with the second programmable threshold level. If determined to be of the second priority, at operation 260, the method may temporarily store the control data packet in a buffer while waiting to transmit the control data packet or packets previously determine to have a first priority.

If the length associated with the control data packet is less than the second programmable threshold level, at operation 270, the method determines that the control data packet has a second priority and, therefore, should be transmitted and processed after the first priority control packets but before those control packets with the third priority. Otherwise, if the length associated with the control data packet is greater than the second programmable threshold level, at operation 280, the method compares the length associated with the control data packet with the third programmable threshold level and determines that the control data packet should be transmitted as the third or lowest priority and, therefore, should be transmitted and processed after all other control packets with a first or second priority are processed. If determined to be of a third priority, at operation 290, the method may temporarily store the control data packet in a buffer while waiting to transmit the control data packet with the first or second priority.

It is to be understood that in the embodiment of the present invention, the operations described in the methods of FIGS. 2 and 3 may be performed in the sequence and manner as shown although the order of some operations and the like may be changed without departing from the spirit and scope of the present invention.

In accordance with an embodiment of the present invention, a control device and method thereof are provided configured to measure a length of a data packet in a control stream and to compare the length with a programmable threshold level and generate a result indicative thereof. The control device and method thereof would prioritize processing of the data packet based on the result. If the result indicates that the length of the data packet is less than the programmable threshold level, the control device and method would determine and process the data packet at a higher priority than other data packets.

Furthermore, while the terms packet and datagram have been used in the description of the present invention, the invention has import to many types of network data. For purposes of this invention, the term packet includes packet, cell, frame, datagram, bridge protocol data unit packet, packet data and any equivalents thereof.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. An apparatus for prioritizing data packets in a control stream, comprising:
a queue configured to receive control data packets of the control stream; and
an arbiter operatively connected to the queue configured to set a threshold level defining a priority to transmit and process each control data packet, to read header attribute information associated with the control data packet, to determine, based on the header attribute information included in the control data packet, a length of each control data packet, and to compare the length of each control data packet with the threshold level to prioritize transmission of the control data packets.

2. The apparatus as recited in claim 1, wherein when the length of a control data packet of the control data packets is less than the threshold level, the arbiter is further configured to determine that the control data packet is of a highest priority than the other control data packets.

3. The apparatus as recited in claim 1, wherein when the length of a control data packet of the control data packets is greater than the threshold level, the arbiter is further configured to determine that the control data packet is of a lower priority than the other control data packets.

4. An apparatus for prioritizing data packets in a control stream, comprising:
a queue configured to receive control data packets of the control stream; and
an arbiter operatively connected to the queue configured to set multiple threshold levels defining a priority to transmit and process each control data packet, to read header attribute information associated with the control data packet, to determine, based on the header attribute information included in the control data packet, a length of each control data packet, and to compare the length of each control data packet with at least one of the multiple threshold levels to prioritize transmission of the control data packets.

5. The apparatus as recited in claim 4, wherein the multiple threshold levels comprise a first threshold level corresponding to a highest priority, a second threshold level corresponding to an intermediate priority, and a third threshold level corresponding to a lowest priority.

6. The apparatus as recited in claim 5, wherein when the length of a control data packet of the control data packets is less than the first threshold level, the arbiter is further configured to determine that the control data packet is of the highest priority than the other control data packets.

7. The apparatus as recited in claim 6, wherein when the length of a control data packet of the control data packets is greater than the first threshold level, the arbiter is further configured to compare the length of the control data packet with the second threshold level.

8. The apparatus as recited in claim 7, wherein when the length of a control data packet of the control data packets is less than the second threshold level, the arbiter is further configured to determine that the control data packet is of the intermediate priority than the other control data packets and that the control data packet is to be transmitted and processed after all other control packets with the first priority are processed.

9. The apparatus as recited in claim 8, wherein when the length of a control data packet of the control data packets is greater than the second threshold level, the arbiter is further configured to compare the length of the control data packet with the third threshold level.

10. The apparatus as recited in claim 9, wherein when the length of a control data packet of the control data packets is less than the third threshold level, the arbiter is further configured to determine that the control data packet is of the lowest priority and that the control data packet is to be transmitted and processed after all other control packets with the first or second priority are processed.

11. An apparatus for prioritizing data packets in a control stream, comprising:
queue means for receiving control data packets of the control stream; and
arbiter means operatively connected to the queue for setting a threshold level defining a priority to transmit and process each control data packet, reading header attribute information associated with the control data packet, determining, based on the header attribute information included in the control data packet, a length of each control data packet, and comparing the length of each control data packet with the threshold level to prioritize transmission of the control data packets.

12. An method for prioritizing data packets in a control stream, comprising:
receiving control data packets of the control stream;
setting a threshold level defining a priority to transmit and process each control data packet;
reading header attribute information associated with the control data packet;
determining, based on the header attribute information included in the control data packet, a length of each control data packet; and
comparing the length of each control data packet with the threshold level to prioritize transmission of the control data packets.

13. The method as recited in claim 12, wherein when the length of a control data packet of the control data packets is less than the threshold level, further comprising:
determining that the control data packet is of a highest priority than the other control data packets.

14. The method as recited in claim 12, wherein when the length of a control data packet of the control data packets is greater than the threshold level, further comprising:
determining that the control data packet is of a lower priority than the other control data packets.

15. An method for prioritizing data packets in a control stream, comprising:
receiving control data packets of the control stream;
setting multiple threshold levels defining a priority to transmit and process each control data packet;
reading header attribute information associated with the control data packet, determining, based on the header attribute information included in the control data packet, a length of each control data packet; and
comparing the length of each control data packet with at least one of the multiple threshold levels to prioritize transmission of the control data packets.

16. The method as recited in claim 15, wherein the multiple threshold levels comprise a first threshold level corresponding to a highest priority, a second threshold level corresponding to an intermediate priority, and a third threshold level corresponding to a lowest priority.

17. The method as recited in claim 16, wherein when the length of a control data packet of the control data packets is less than the first threshold level, further comprising:
determining that the control data packet is of the highest priority than the other control data packets.

18. The method as recited in claim 17, wherein when the length of a control data packet of the control data packets is greater than the first threshold level, further comprising:
comparing the length of the control data packet with the second threshold level.

19. The method as recited in claim 18, wherein when the length of a control data packet of the control data packets is less than the second threshold level, further comprising:
determining that the control data packet is of the intermediate priority than the other control data packets and that the control data packet is to be transmitted and processed after all other control packets with the first priority are processed.

20. The method as recited in claim 19, wherein when the length of a control data packet of the control data packets is greater than the second threshold level, further comprising:
comparing the length of the control data packet with the third threshold level.

21. The method as recited in claim 20, wherein when the length of a control data packet of the control data packets is less than the third threshold level, further comprising:
determining that the control data packet is of the lowest priority and that the control data packet is to be transmitted and processed after all other control packets with the first or second priority are processed.
